(19) United States
(12) Patent Application Publication
(10) Pub. No.: US 2023/0036294 A1
(43) Pub. Date: Feb. 2, 2023

(54) METHOD FOR PROCESSING IMAGE, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Bo JU, Beijing (CN); Xiaoqing YE, Beijing (CN); Xiao TAN, Beijing (CN); Hao SUN, Beijing (CN)

(21) Appl. No.: 17/936,609

(22) Filed: Sep. 29, 2022

(30) Foreign Application Priority Data
Sep. 30, 2021 (CN) 202111160345.X

(51) Int. Cl. G06T 5/00; G06T 19/00; G01S 17/89; G01S 7/48

(52) U.S. Cl. CPC G06T 5/002; G06T 19/00; G01S 17/89; G01S 7/4808; G06T 2207/10028; G06T 2207/30261; G06T 2219/008

(57) ABSTRACT

Disclosed are a method for processing an image, an electronic device, and a storage medium. The method includes: acquiring a plurality of point cloud grids from a gridded point cloud map; determining each reference plane with the number of sampling points matched being greater than or equal to a threshold from the initial planes corresponding respectively to the plurality of the point cloud grids; correcting the initial planes corresponding respectively to the plurality of point cloud grids based on each reference plane to obtain target planes corresponding respectively to the plurality of point cloud grids; and performing denoise processing on sampling points based on the target plane of each point cloud grid.

### CROSS REFERENCE TO RELATED APPLICATIONS

This application is based on and claims priority to Chinese Patent Application Serial No. 202111160345.X, filed on Sep. 30, 2021, the entire disclosure of which is incorporated herein by reference.

### TECHNICAL FIELD

The disclosure relates to a field of artificial intelligence (AI) technologies, and particularly to computer vision and deep learning, and specifically to a method and an apparatus for processing an image, an electronic device and a storage medium, which may be applied to smart cities and autonomous scenes.

### BACKGROUND

A LiDAR plays a key role in an autonomous system. The autonomous system may accurately perform real-time 3D modeling on an environment where a vehicle is located by the LiDAR, particularly in a scene where a camera-based visual perception system fails, such as fog, night, white vehicle or the like. The LiDAR may greatly improve a safety of the autonomous system, and accurately perceive the position, size and pose of a certain 3D target (such as a vehicle, a pedestrian) in a LiDAR point cloud coordinate system, which is referred to as a radar point cloud 3D target detection task.

A point cloud 3D target detection task is taken as a classical subtask in the computer vision. Since point cloud data acquired by the LiDAR is characterized by irregularity, disorder, sparseness and noise, sensor noise may have an important influence on subsequent detection of the LiDAR point cloud. Further, besides the device itself, environmental factors such as outdoor strong light, rain, snow and fog weather may also lead to surge of point cloud noise. Therefore, it is particularly important to perform high-quality denoise processing on a point cloud map.

### SUMMARY

A method for processing an image, an electronic device and a storage medium are provided in the disclosure.

According to an aspect of the disclosure, a method for processing an image is provided. The method includes: acquiring a gridded point cloud map, in which the gridded point cloud map includes a plurality of point cloud grids, and each point cloud grid includes a plurality of sampling points; for each point cloud grid, performing plane fitting on the plurality of sampling points in the point cloud grid to obtain an initial plane corresponding to the point cloud grid and a number of sampling points matched with the initial plane in the point cloud grid; determining each initial plane with the number of sampling points matched being greater than or equal to a threshold from the initial planes corresponding respectively to the plurality of the point cloud grids as a reference plane; correcting the initial planes corresponding respectively to the plurality of point cloud grids based on each reference plane to obtain target planes corresponding respectively to the plurality of point cloud grids; and performing denoise processing on the plurality of sampling points in each point cloud grid based on the target plane corresponding to the point cloud grid.

According to another aspect of the disclosure, an electronic device is provided, and includes: at least one processor; and a memory communicatively connected to the at least one processor. The memory is stored with instructions executable by the at least one processor, to cause the at least one processor to perform steps of the method as described in the above aspect of the disclosure.

According to another aspect of the disclosure, a non-transitory computer readable storage medium stored with computer instructions is provided. The computer instructions are configured to cause a computer to perform steps of the method as described in the above aspect.

According to another aspect of the disclosure, a computer program product including a computer program is provided. The computer program implements steps of the method as described in the above any aspect when performed by a processor.

It should be understood that, the content described in the part is not intended to identify key or important features of embodiments of the disclosure, nor intended to limit the scope of the disclosure. Other features of the disclosure will be easy to understand through the following specification.

### BRIEF DESCRIPTION OF THE DRAWINGS

The drawings are intended to better understand the solution, and do not constitute a limitation to the disclosure.

FIG. 1 is a flowchart of a method for processing an image provided in an embodiment of the disclosure;

FIG. 2 is a schematic diagram of a gridded point cloud map in one scene provided in an embodiment of the disclosure;

FIG. 3 is a flowchart of a method for processing an image provided in an embodiment of the disclosure;

FIG. 4 is a schematic diagram of a process of determining a target plane for a point cloud grid provided in an embodiment of the disclosure;

FIG. 5 is a flowchart of a method for processing an image provided in an embodiment of the disclosure;

FIG. 6 is a block diagram of an apparatus for processing an image provided in an embodiment of the disclosure;

FIG. 7 is a block diagram of an electronic device 700 provided in an embodiment of the disclosure.

### DETAILED DESCRIPTION

The embodiments of the present disclosure are described as below with reference to the accompanying drawings, which include various details of embodiments of the present disclosure to facilitate understanding, and should be considered as merely exemplary. Therefore, those skilled in the art should realize that various changes and modifications may be made to the embodiments described herein without departing from the scope and spirit of the present disclosure. Similarly, for clarity and conciseness, descriptions of well-known functions and structures are omitted in the following descriptions.

A method and an apparatus for processing an image, an electronic device and a storage medium in the embodiment of the disclosure are described below with reference to accompanying drawings.

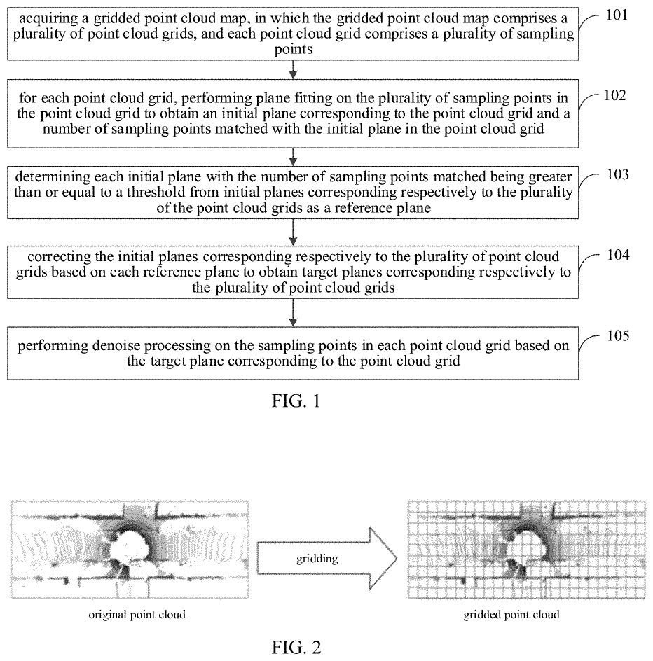

FIG. 1 is a flowchart of a method for processing an image provided in an embodiment of the disclosure.

As illustrated in FIG. 1, the method may include the followings.

At block 101, a gridded point cloud map is acquired. The gridded point cloud map includes a plurality of point cloud grids, each of the point cloud grids includes a plurality of sampling points.

In the embodiment of the disclosure, an original point cloud map collected by a LiDAR sensor is acquired, the original point cloud map includes a plurality of scattered point clouds, i.e., sampling points. Each sampling point includes three floating point values X, Y, Z representing a spatial position. A preset grid size is adopted to perform two-dimensional plane gridding on the original point cloud map, mainly acting on an x-y axis.

An empirical value is taken as the gird size based on a performance of different LiDARs, in which, a large grid size results in unable to effectively remove noise, and a small grid size results in removing excessive sampling points, further resulting in an inaccurate result, therefore, a compromise between performance and efficiency is achieved by setting the grid size.

FIG. 2 illustrates a gridded point cloud map acquired by performing gridding on an original point cloud map acquired based on a LiDAR sensor of a vehicle in an automatic driving scene.

At block 102, for each point grid, plane fitting is performed on a plurality of sampling points in the point cloud grid to obtain an initial plane corresponding to the point cloud grid and a number of sampling points matched with the initial plane in the point cloud grid.

In the embodiment of the disclosure, for each point grid, the plane fitting is performed based on a plurality of sampling points in the point cloud grid. As a possible implementation, the plane fitting may be performed by a least square method, such as a random sample consensus (RANSAC) algorithm and a singular value decomposition (SVD) algorithm, to obtain an initial plane corresponding to the point cloud grid. The initial plane may be represented by an initial plane equation, specifically represented as Ax+By+Cz+D=0, that is, the equation indicates a corresponding plane, in which, x, y and z are three-dimensional coordinates of a cloud point (i.e., a sampling point) in the acquired laser point cloud. A plane has a corresponding normal vector, and the normal vector is determined based on the parameters A, B and C.

In the embodiment of the disclosure, after the initial plane corresponding to each point cloud grid is determined, for each point cloud grid, three-dimensional coordinates of each sampling point in the point cloud grid are input into an initial plane corresponding to the point cloud grid. For example, when the three-dimensional coordinates are (x₁, y₁, z₁) are input in the initial plane, Ax₁+By₁+Cz₁=N. In order to improve a matching accuracy, the output result N is compared with a preset threshold range. The corresponding sampling point is matched with the plane if N is within the preset threshold range, while the corresponding sampling point is not matched with the plane if N is not within the preset threshold range. Thus, the number of sampling points matched with each of the initial planes in a corresponding point cloud grid can be determined.

At block 103, each initial plane with the number of sampling points matched being greater than or equal to a threshold is determined from the initial planes corresponding respectively to the plurality of the point cloud grids as a reference plane.

In the embodiment of the disclosure, the more the sampling points matched with the initial plane in the corresponding point cloud grid, the more the cloud points (sampling points) on the initial plane, the higher the accuracy of the initial plane. Therefore, the initial plane corresponding to the point cloud grid with the number of sampling points matched being greater than or equal to the threshold is taken from the initial planes corresponding to the point cloud grids as a reference plane, so that the reference plane has higher accuracy.

At block 104, the initial planes corresponding respectively to the plurality of point cloud grids are corrected based on each reference plane to obtain target planes corresponding respectively to the plurality of point cloud grids.

In the embodiment of the disclosure, for a point cloud grid, the farther it is away from an acquisition center, the sparser the point cloud data. Therefore, an accuracy of the initial plane of the point cloud grid corresponding to a far end or an uneven region is poor. In the embodiment of the disclosure, the initial plane corresponding to each point cloud grid is corrected by taking the reference plane with a high accuracy determined as a reference to obtain a target plane corresponding to each point cloud grid, so that when the remote ground point cloud is very sparse or even when the point cloud disappears, a relatively reasonable plane can be estimated by the correction process, which improves the accuracy of the target plane corresponding to each point cloud grid, and may be applied to various complex ground situations, such as curved ground conditions.

It should be noted that, in the correction process of the embodiment of the disclosure, initial planes of all point cloud grids may be corrected based on each reference plane, or initial planes corresponding to point cloud grids other than the point cloud grids corresponding respectively to the reference planes are corrected based on each reference plane.

At block 105, denoise processing is performed on the sampling points in each point cloud grid based on the target plane corresponding to the point cloud grid.

In the embodiment of the disclosure, based on the target plane corresponding to each point cloud grid, the sampling points in each point cloud grid are input into the target plane. The sampling points not satisfying a preset condition are deleted on the basis of each accurate target plane, for example, each sampling point above the plane is deleted, or each sampling point below the plane is deleted, to improve the denoising effect of a point cloud map.

In the method for processing an image according to the embodiment of the disclosure, a plurality of point cloud grids included in a gridded point cloud map are acquired, and plane fitting is performed on a plurality of sampling points in each point cloud grid to obtain an initial plane of each point cloud grid, each reference plane with the number of sampling points matched being greater than or equal to a threshold is determined from the initial planes corresponding respectively to the plurality of the point cloud grids, an initial plane corresponding to each of the point cloud grids is corrected based on each of the reference planes to obtain a target plane corresponding to each of the point cloud grids, and denoise processing is performed on the sampling points in each of the point cloud grids based on the target plane corresponding to each of the point cloud grids. By determining a reference plane from the initial planes obtained by fitting the sampling points in the point cloud grid, and correcting the initial plane of each point cloud grid based on the reference plane to obtain a target plane of each point cloud grid, the accuracy of determining a target plane of the point cloud grid in each area is improved, and further the accuracy of denoise processing on a point cloud map is improved by performing the denoise processing on sampling points based on the target plane of each point cloud grid.

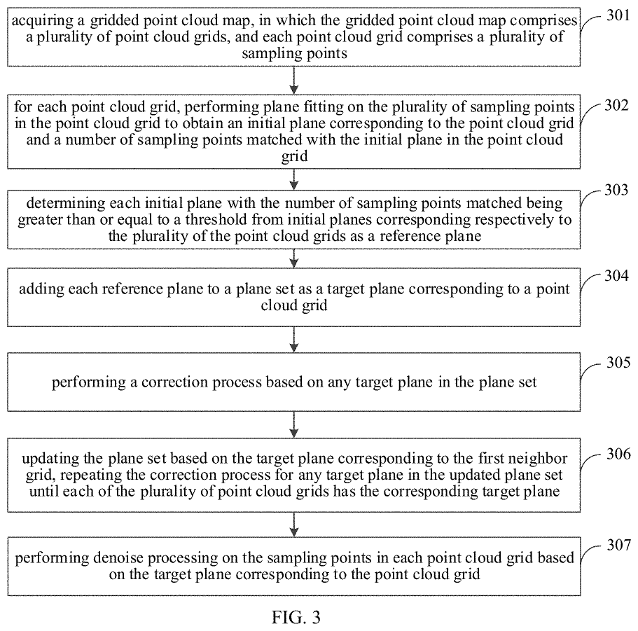

Based on the above embodiment, another method for processing an image is provided in the embodiment of the disclosure. FIG. 3 is a flowchart of a method for processing an image provided in an embodiment of the disclosure, which illustrates how to correct the initial plane corresponding to each grid based on the reference plane to improve the accuracy of a corresponding target plane. As illustrated in FIG. 3, the method may include the followings.

At block 301, a gridded point cloud map is acquired. The gridded point cloud map includes a plurality of point cloud grids, each of the point cloud grids includes a plurality of sampling points.

At block 302, for each point cloud grid, plane fitting is performed on the plurality of sampling points in the point cloud grid to obtain an initial plane corresponding to the point cloud grid and a number of sampling points matched with the initial plane in the point cloud grid.

At block 303, each initial plane with the number of sampling points matched being greater than or equal to a threshold is determined from the initial planes corresponding respectively to the plurality of the point cloud grids as a reference plane.

Specifically, blocks 301 to 303 may refer to descriptions of the foregoing method embodiment, which will not be repeated here.

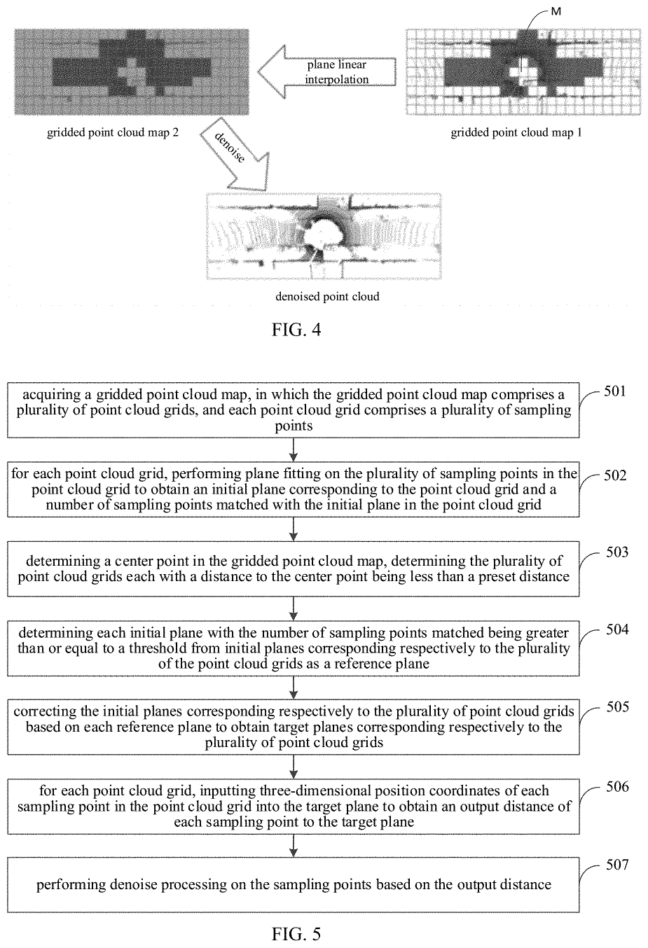

As illustrated in FIG. 4, a plane of each gray grid in a gridded point cloud map 1 is determined as a reference plane.

At block 304, each reference plane is added to a plane set as a target plane corresponding to a point cloud grid.

In the embodiment of the disclosure, an accuracy of the reference plane is high, and the reference plane may be taken as a target plane of a corresponding point cloud grid, that is, the plane of the point cloud grid corresponding to the reference plane does not need to be corrected, that is, the plane of each dark grey grid in the gridded point cloud map 1 in FIG. 4 does not need to be corrected, and for each of the dark grey point cloud grids, the reference plane is taken as a target plane of the point cloud grid, which improves the efficiency. The plane equations corresponding to the target planes of the dark grey point cloud grids is added to the plane set for correcting the initial planes of a plurality of grids other than the dark grey grids, that is, the initial plane of each white grid in the gridded point cloud map 1 is corrected to improve the accuracy for each point cloud grid.

At block 305, a correction process is performed based on any target plane in the plane set.

The correction process includes: determining a first neighbor grid of a point cloud grid corresponding to the target plane, and determining a second neighbor grid corresponding to another target plane from neighbor grids of the first neighbor grid in response to the number of sampling points matched with the initial plane corresponding to the first neighbor grid being less than the threshold; interpolating the target plane and the another target plane corresponding to the second neighbor grid to obtain a target plane corresponding to the first neighbor grid. For an interpolation correction method, as an implementation, the target plane and another target plane corresponding to the second neighbor grid may be averaged to obtain the target plane corresponding to the first neighbor grid. As another implementation, weights of the target plane and the another target plane of the second neighbor grid may be determined based on the number of sampling points matched in the target plane and the another target plane corresponding to the second neighbor grid, and the target plane corresponding to the first neighbor grid is obtained by weighted averaging.

At block 306, the plane set is updated based on the target plane corresponding to the first neighbor grid, and the correction process is repeated based on any target plane in the updated plane set until each of the plurality of point cloud grids has the corresponding target plane.

In the embodiment of the disclosure, the plane set is updated based on the target plane corresponding to the first neighbor grid obtained by performing the correction process based on the reference plane, which increases the target planes for correcting each grid having no determined target plane included in the plane set. The number of point cloud grids each having the determined target plane in the plane set is increasing by constantly performing the correction process. Further, the correction process is repeated by constantly increasing the target planes included in the set, until all point grid grids have corresponding target planes, that is, for each light grey point cloud grid in a gridded point cloud grid map 2 in FIG. 4, interpolation correction is performed to obtain a corresponding target plane. In a complex scene where the terrain changes greatly, a relatively reasonable plane may be estimated by the correction process in a situation where the remote ground point cloud is very sparse or even when the point cloud disappears, and the calculation amount is relatively small.

At block 307, denoise processing is performed on the sampling points in each of the point cloud grids based on the target plane corresponding to each of the point cloud grids.

Specifically, it may refer to descriptions of the foregoing embodiments, which will not be repeated here.

In the method for processing an image according to the embodiment of the disclosure, the plane set is updated based on the target plane corresponding to the first neighbor grid obtained by performing a correction process based on the reference plane, which increases the target planes for correcting each grid having no determined target plane included in the plane set. The number of point cloud grids each having the determined target plane in the set is increasing by constantly performing the correction process. Further, the correction process is repeated by constantly increasing the target planes included in the set, until all point grid grids have corresponding target planes. In a complex scene where the terrain changes greatly, a relatively reasonable plane can be estimated by the correction process in a situation where the remote ground point cloud is very sparse or even when the point cloud disappears, and the calculation amount is relatively small.

Based on the above embodiments, another method for processing an image is provided in the embodiment of the disclosure. FIG. 5 is a flowchart of a method for processing an image provided in an embodiment of the disclosure. As illustrated in FIG. 5, the method includes the followings.

At block 501, a gridded point cloud map is acquired. The gridded point cloud map includes a plurality of point cloud grids, each of the point cloud grids includes a plurality of sampling points.

At block 502, for each point cloud grid, plane fitting is performed on the plurality of sampling points in the point cloud grid to obtain an initial plane corresponding to the point cloud grid and a number of sampling points matched with the initial plane in the point cloud grid.

Specifically, it may refer to descriptions of the foregoing method embodiments, with the same principle, which will not be repeated here.

At block 503, a center point in the gridded point cloud map is determined, and a plurality of point cloud grids each with a distance to the center point being less than a preset distance are determined.

The center point is located at a mapping position of a laser sensor acquiring the point cloud map in the point cloud map, that is, a position of a LiDAR in a point cloud coordinate, for example, the point M in FIG. 4 indicates a position of the center point.

In the embodiment of the disclosure, a mapping position of a laser sensor acquiring a point cloud map in the point cloud map is taken as a center point, and a plurality of point cloud grids each with a distance to the center point being less than a preset distance are determined, to screen out reference planes from the initial planes corresponding to the plurality of point cloud grids satisfying a distance requirement. The nearer the distance to the center is, the richer the point cloud data included is, thereby improving the accuracy and efficiency of determining the reference plane.

At block 504, each initial plane with the number of sampling points matched being greater than or equal to a threshold value is determined from the initial planes corresponding respectively to the plurality of the point cloud grids as a reference plane.

At block 505, the initial planes corresponding respectively to the plurality of point cloud grids are corrected based on each reference plane to obtain target planes corresponding respectively to the plurality of point cloud grids.

Specifically, it may refer to descriptions of the foregoing method embodiments, with the same principle, which will not be repeated here.

At block 506, for each point cloud grid, three-dimensional position coordinates of each sampling point in the point cloud grid are input into the target plane to obtain an output distance of each sampling point to the target plane.

At block 507, denoise processing is performed on the sampling points based on the output distance.

In the embodiment of the disclosure, for each point cloud grid, the distance from each sampling point in the corresponding grid to the corresponding target plane is calculated. The larger the distance of the sampling point to the plane, the smaller the probability that the sampling point is located on the plane. The sampling points each with the distance exceeding the preset threshold are deleted based on the distance, to achieve the denoise processing on the sampling points in the corresponding grid, which improves the denoise accuracy.

In one scene of the embodiment of the disclosure, for each point cloud grid, when sampling points below the target plane of the corresponding point cloud grid are deleted, it is determined that a normal vector of the target plane of the point cloud grid is perpendicular to the target plane and directed upwardly, and a first sampling point with the output distance being a negative value and less than a preset threshold is determined and deleted, to remove each sampling point below the point cloud grid, which achieves the denoise processing on the specific sampling points in the point cloud grid, and satisfies the denose requirements in different scenes.

In one scene of the embodiment of the disclosure, for each point cloud grid, when sampling points above the target plane of the corresponding point cloud grid are deleted, it is determined that a normal vector of the target plane of the point cloud grid is perpendicular to a target plane and directed downwardly, and a second sampling point with the output distance being a positive value and less than a preset threshold is determined and deleted, to remove each sampling point above the point cloud grid, which achieves the denoise processing on the specific sampling points in the point cloud grid, and satisfies the denose requirements in different scenes.

In the method for processing an image according to the embodiment of the disclosure, a mapping position of a laser sensor acquiring a point cloud map in the point cloud map is taken as a center point, and a plurality of point cloud grids each with the distance to the center point being less than a preset distance are determined, to screen out reference planes from the initial planes corresponding to the plurality of point cloud grids satisfying a distance requirement, thereby improving the accuracy and efficiency of determining the reference plane. Denoise processing may be performed on the specific sampling points in the point cloud grid, which satisfies the denosing requirements in different scenes.

In order to achieve the above embodiment, an apparatus for processing an image is provided in an embodiment of the disclosure.

FIG. 6 is a block diagram of an apparatus for processing an image provided in an embodiment of the disclosure. As illustrated in FIG. 6, the apparatus includes an acquiring module 61, a fitting module 62, a first determining module 63, a correcting module 64 and a denosing module 65.

The acquiring module 61 is configured to acquire a gridded point cloud map, in which the gridded point cloud map includes a plurality of point cloud grids and each point cloud grid includes a plurality of sampling points.

The fitting module 62 is configured to, for each point cloud grid, perform plane fitting on the plurality of sampling points in the point cloud grid to obtain an initial plane corresponding to the point cloud grid and a number of sampling points matched with the initial planes in the point cloud grid.

The first determining module 63 is configured to determine each initial plane with the number of sampling points matched being greater than or equal to a threshold value from the initial planes corresponding respectively to the plurality of the point cloud grids as a reference plane.

The correcting module 64 is configured to correct the initial planes corresponding respectively to the plurality of point cloud grids based on each of the reference planes to obtain target planes corresponding respectively to the plurality of point cloud grids.

The denosing module 65 is configured to perform denoise processing on the sampling points in each point cloud grid based on the target plane corresponding to the point cloud grid.

In an implementation of the embodiment of the disclosure, the correcting module 64 is further configured to: add each reference plane to a plane set as a target plane corresponding to a point cloud grid; perform a correction process based on any target plane in the plane set, in which the correction process comprises: determining a first neighbor grid of a point cloud grid corresponding to the target plane, and determining a second neighbor grid corresponding to another target plane from neighbor grids of the first neighbor grid in response to the number of sampling points matched with the initial plane corresponding to the first neighbor grid being less than the threshold; interpolating the target plane and the another target plane corresponding to the second neighbor grid to obtain a target plane corresponding to the first neighbor grid; update the plane set based on the target plane corresponding to the first neighbor grid; and repeat the correction process for any target plane in the updated plane set until each of the plurality of point cloud grids has the corresponding target plane.

In an implementation of the embodiment of the disclosure, the denosing module 65 is further configured to: for each point cloud grid, input three-dimensional position coordinates of each sampling point in the point cloud grid into the target plane to obtain an output distance of each sampling point to the target plane; and perform the denoise processing on the sampling points based on the output distance.

In an implementation of the embodiment of the disclosure, the denosing module 65 is further configured to: determine that a normal vector of the target plane of the point cloud grid is perpendicular to a target plane and directed upwardly; determine a first sampling point with the output distance being a negative value and less than a preset threshold; and perform the denoise processing on the sampling points by deleting the first sampling point.

In one implementation of the embodiment of the disclosure, the apparatus further includes a second determining module.

The second determining module is configured to determine a center point in the gridded point cloud map, in which the center point is located at a mapping position of a laser sensor acquiring the gridded point cloud map in the gridded point cloud map; and determine the plurality of point cloud grids each with a distance to the center point being less than a preset distance.

It needs to be understood that, the foregoing explanation of the method embodiment is also applied to an apparatus in the embodiment, with the same principle, which will not be repeated here.

In the apparatus for processing an image according to the embodiment of the disclosure, a plurality of point cloud grids included in a gridded point cloud map are acquired, and plane fitting is performed on a plurality of sampling points in each point cloud grid to obtain an initial plane of each point cloud grid, each reference plane with the number of sampling points matched being greater than or equal to a threshold is determined from the initial planes corresponding respectively to the plurality of the point cloud grids, an initial plane corresponding to each of the point cloud grids is corrected based on each of the reference planes to obtain a target plane corresponding to each of the point cloud grids, and denoise processing is performed on the sampling points in each of the point cloud grids based on the target plane corresponding to each of the point cloud grids. By determining a reference plane from the initial planes obtained by fitting the sampling points in the point cloud grid, and correcting the initial plane of each point cloud grid based on the reference plane to obtain a target plane of each point cloud grid, the accuracy of determining a target plane of the point cloud grid in each area is improved, and further the accuracy of denoise processing on a point cloud map is improved by performing the denoise processing on sampling points based on the target plane of each point cloud grid.

In order to achieve the above embodiment, an electronic device is further provided in the embodiment of the disclosure. The device includes: at least one processor; and a memory communicatively connected to the at least one processor; the memory is stored with instructions executable by the at least one processor, to cause the at least one processor to perform the steps of the method as described in the above method embodiment.

In order to achieve the above embodiment, a non-transitory computer readable storage medium stored with computer instructions is provided in the embodiment of the disclosure. The computer instructions are configured to cause a computer to perform the steps of the method as described in the above method embodiment.

In order to achieve the above embodiment, a computer program product including a computer program is further provided. The computer program implements the steps of the method as described in the above method embodiment when performed by a processor.

According to the embodiment of the disclosure, an electronic device, a readable storage medium and a computer program product are further provided in the disclosure.

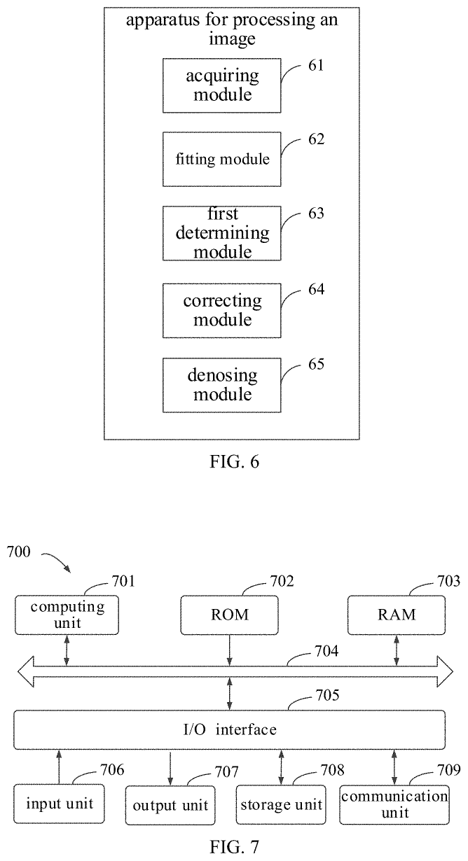

FIG. 7 is a schematic block diagram of an electronic device 700 provided in the embodiment of the disclosure. An electronic device is intended to represent various types of digital computers, such as laptop computers, desktop computers, workstations, personal digital assistants, servers, blade servers, mainframe computers, and other suitable computers. An electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 7, a device 700 includes a computing unit 701, which may be configured to execute various appropriate actions and processes according to a computer program stored in a read-only memory (ROM) 702 or loaded from a storage unit 708 to a random access memory (RAM) 703. In a RAM 703, various programs and data required by an operation of a device 700 may be further stored. A computing unit 701, a ROM 702 and a RAM 703 may be connected with each other by a bus 704. An input/output (I/O) interface 705 is also connected to a bus 704.

A plurality of components in the device 700 are connected to an I/O interface 705, and includes: an input unit 706, for example, a keyboard, a mouse, etc.; an output unit 707, for example various types of displays, speakers; a storage unit 708, for example a magnetic disk, an optical disk; and a communication unit 709, for example, a network card, a modem, a wireless transceiver. The communication unit 709 allows a device 700 to exchange information/data through a computer network such as internet and/or various types of telecommunication networks and other devices.

The computing unit 701 may be various types of general and/or dedicated processing components with processing and computing ability. Some examples of a computing unit 701 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 701 performs various methods and processings as described above, for example, a method for processing an image. For example, in some embodiments, the method for processing an image may be further achieved as a computer software program, which is physically contained in a machine readable medium, such as a storage unit 708. In some embodiments, a part or all of the computer program may be loaded and/or installed on the device 700 via a ROM 702 and/or a communication unit 709. When the computer program is loaded on a RAM 703 and performed by a computing unit 701, one or more blocks in the above method for processing an image may be performed. Alternatively, in other embodiments, the computing unit 701 may be configured to perform a method for processing an image in other appropriate ways (for example, by virtue of a firmware).

Various implementation modes of systems and technologies described herein may be implemented in a digital electronic circuit system, an integrated circuit system, a field programmable gate array (FPGA), a dedicated application specific integrated circuit (ASIC), an application specific standard product (ASSP), a system on a chip (SoC), a complex programmable logic device (CPLD), a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the present disclosure may be written with one or any combination of a plurality of programming languages. The programming languages may be provided to a processor or a controller of a general purpose computer, a dedicated computer, or other apparatuses for programmable data processing so that the function/operation specified in the flowchart and/or block diagram may be performed when the program code is executed by the processor or controller. A computer code may be performed completely or partly on the machine, performed partly on the machine as an independent software package and performed partly or completely on the remote machine or server.

In the context of the disclosure, a machine-readable medium may be a tangible medium that may contain or store a program intended for use in or in conjunction with an instruction execution system, apparatus, or device. A machine readable medium may be a machine readable signal medium or a machine readable storage medium. A machine readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a RAM, a ROM, an electrically programmable read-only memory (an EPROM) or a flash memory, an optical fiber device, and a compact disc read-only memory (CD-ROM), an optical storage device, a magnetic storage device, or any appropriate combination thereof.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may be further configured to provide interaction with the user; for example, the feedback provided to the user may be any form of sensory feedback (for example, visual feedback, auditory feedback, or tactile feedback); and input from the user may be received in any form (including an acoustic input, a voice input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). The examples of a communication network include a Local Area Network (LAN), a Wide Area Network (WAN), an internet and a blockchain network.

The computer system may include a client and a server. The client and server are generally far away from each other and generally interact with each other through a communication network. The relationship between the client and the server is generated by computer programs running on the corresponding computer and having a client-server relationship with each other. A server may be a cloud server, also known as a cloud computing server or a cloud host, is a host product in a cloud computing service system, to solve the shortcomings of large management difficulty and weak business expansibility existed in the conventional physical host and Virtual Private Server (VPS) service. A server further may be a server with a distributed system, or a server in combination with a blockchain.

It should be noted that, Artificial intelligence (AI) is a subject that learns simulating certain thinking processes and intelligent behaviors (such as learning, reasoning, thinking, planning, etc.) of human beings by a computer, which covers hardware-level technologies and software-level technologies. AI hardware technologies generally include technologies such as sensors, dedicated AI chips, cloud computing, distributed storage, big data processing, etc.; AI software technologies mainly include computer vision technology, speech recognition technology, natural language processing (NLP) technology and machine learning (ML), deep learning (DL), big data processing technology, knowledge graph (KG) technology, etc.

It should be understood that, various forms of procedures shown above may be configured to reorder, add or delete blocks. For example, blocks described in the disclosure may be executed in parallel, sequentially, or in different orders, as long as the desired result of the technical solution disclosed in the present disclosure may be achieved, which will not be limited herein.

The above specific implementations do not constitute a limitation on the protection scope of the disclosure. Those skilled in the art should understand that various modifications, combinations, sub-combinations and substitutions may be made according to design requirements and other factors. Any modification, equivalent replacement, improvement, etc., made within the spirit and principle of embodiments of the present disclosure shall be included within the protection scope of the present disclosure.

What is claimed is:

1. A method for processing an image, comprising:
acquiring a gridded point cloud map, wherein the gridded point cloud map comprises a plurality of point cloud grids, and each point cloud grid comprises a plurality of sampling points;
for each point cloud grid, performing plane fitting on the plurality of sampling points in the point cloud grid to obtain an initial plane corresponding to the point cloud grid and a number of sampling points matched with the initial plane in the point cloud grid;
determining each initial plane with the number of sampling points matched being greater than or equal to a first threshold from initial planes corresponding respectively to the plurality of point cloud grids as a reference plane;
correcting the initial planes corresponding respectively to the plurality of point cloud grids based on each reference plane to obtain target planes corresponding respectively to the plurality of point cloud grids; and
performing denoise processing on the plurality of sampling points in each point cloud grid based on the target plane corresponding to the point cloud grid.

2. The method of claim 1, wherein, correcting the initial planes corresponding respectively to the plurality of point cloud grids based on each reference plane to obtain the target planes corresponding respectively to the plurality of point cloud grids, comprises:
adding each reference plane to a plane set as a target plane corresponding to a point cloud grid;
performing a correction process based on any target plane in the plane set, wherein, the correction process comprises: determining a first neighbor grid of a point cloud grid corresponding to the target plane, and determining a second neighbor grid corresponding to another target plane from neighbor grids of the first neighbor grid in response to the number of sampling points matched with the initial plane corresponding to the first neighbor grid being less than the first threshold; interpolating the target plane and the another target plane corresponding to the second neighbor grid to obtain a target plane corresponding to the first neighbor grid;
updating the plane set based on the target plane corresponding to the first neighbor grid; and
repeating the correction process for any target plane in the updated plane set until each of the plurality of point cloud grids has the corresponding target plane.

3. The method of claim 1, wherein, performing the denoise processing on the plurality of sampling points in each point cloud grid based on the target plane corresponding to the point cloud grid, comprises:
for each point cloud grid, inputting three-dimensional position coordinates of each sampling point in the point cloud grid into the target plane to obtain an output distance of each sampling point to the target plane; and
performing the denoise processing on the plurality of sampling points based on the output distance.

4. The method of claim 3, wherein, performing the denoise processing on the plurality of sampling points based on the output distance, comprises:
determining that a normal vector of the target plane of the point cloud grid is perpendicular to the target plane and directed upwardly;
determining a first sampling point with the output distance being a negative value and less than a second threshold; and
performing the denoise processing on the plurality of sampling points by deleting the first sampling point.

5. The method of claim 3, wherein, performing the denoise processing on the plurality of sampling points based on the output distance, comprises:
determining that a normal vector of the target plane of the point cloud grid is perpendicular to the target plane and directed downwardly;
determining a first sampling point with the output distance being a positive value and less than a second threshold; and
performing the denoise processing on the plurality of sampling points by deleting the first sampling point.

6. The method of claim 1, wherein, before determining each initial plane with the number of sampling points matched being greater than or equal to the first threshold from the initial planes corresponding respectively to the plurality of the point cloud grids as the reference plane, the method further comprises:
determining a center point in the gridded point cloud map, wherein the center point is located at a mapping position of a laser sensor acquiring the gridded point cloud map in the gridded point cloud map; and
determining the plurality of point cloud grids each with a distance to the center point being less than a preset distance.

7. An electronic device, comprising:
at least one processor; and
a memory communicatively connected to the at least one processor;
wherein, the memory is stored with instructions executable by the at least one processor, to cause the at least one processor to perform the following:
acquiring a gridded point cloud map, wherein the gridded point cloud map comprises a plurality of point cloud grids, and each point cloud grid comprises a plurality of sampling points;
for each point cloud grid, performing plane fitting on the plurality of sampling points in the point cloud grid to obtain an initial plane corresponding to the point cloud grid and a number of sampling points matched with the initial plane in the point cloud grid;
determining each initial plane with the number of sampling points matched being greater than or equal to a first threshold from initial planes corresponding respectively to the plurality of point cloud grids as a reference plane;
correcting the initial planes corresponding respectively to the plurality of point cloud grids based on each reference plane to obtain target planes corresponding respectively to the plurality of point cloud grids; and
performing denoise processing on the plurality of sampling points in each point cloud grid based on the target plane corresponding to the point cloud grid.

8. The device of claim 7, wherein, correcting the initial planes corresponding respectively to the plurality of point cloud grids based on each reference plane to obtain the target planes corresponding respectively to the plurality of point cloud grids, comprises:
adding each reference plane to a plane set as a target plane corresponding to a point cloud grid;
performing a correction process based on any target plane in the plane set, wherein, the correction process comprises: determining a first neighbor grid of a point cloud grid corresponding to the target plane, and determining a second neighbor grid corresponding to another target plane from neighbor grids of the first neighbor grid in response to the number of sampling points matched with the initial plane corresponding to the first neighbor grid being less than the first threshold; interpolating the target plane and the another target plane corresponding to the second neighbor grid to obtain a target plane corresponding to the first neighbor grid;
updating the plane set based on the target plane corresponding to the first neighbor grid; and
repeating the correction process for any target plane in the updated plane set until each of the plurality of point cloud grids has the corresponding target plane.

9. The device of claim 7, wherein, performing the denoise processing on the plurality of sampling points in each point cloud grid based on the target plane corresponding to the point cloud grid, comprises:
for each point cloud grid, inputting three-dimensional position coordinates of each sampling point in the point cloud grid into the target plane to obtain an output distance of each sampling point to the target plane; and
performing the denoise processing on the plurality of sampling points based on the output distance.

10. The device of claim 9, wherein, performing the denoise processing on the plurality of sampling points based on the output distance, comprises:
determining that a normal vector of the target plane of the point cloud grid is perpendicular to the target plane and directed upwardly;
determining a first sampling point with the output distance being a negative value and less than a second threshold; and
performing the denoise processing on the plurality of sampling points by deleting the first sampling point.

11. The device of claim 9, wherein, performing the denoise processing on the plurality of sampling points based on the output distance, comprises:
determining that a normal vector of the target plane of the point cloud grid is perpendicular to the target plane and directed downwardly;
determining a first sampling point with the output distance being a positive value and less than a second threshold; and
performing the denoise processing on the plurality of sampling points by deleting the first sampling point.

12. The device of claim 7, wherein, the at least one processor is further caused to perform the followings:
determining a center point in the gridded point cloud map, wherein the center point is located at a mapping position of a laser sensor acquiring the gridded point cloud map in the gridded point cloud map; and
determining the plurality of point cloud grids each with a distance to the center point being less than a preset distance.

13. A non-transitory computer readable storage medium stored with computer instructions, wherein, the computer instructions are configured to cause a computer to perform the following:
acquiring a gridded point cloud map, wherein the gridded point cloud map comprises a plurality of point cloud grids, and each point cloud grid comprises a plurality of sampling points;
for each point cloud grid, performing plane fitting on the plurality of sampling points in the point cloud grid to obtain an initial plane corresponding to the point cloud grid and a number of sampling points matched with the initial plane in the point cloud grid;
determining each initial plane with the number of sampling points matched being greater than or equal to a first threshold from initial planes corresponding respectively to the plurality of point cloud grids as a reference plane;
correcting the initial planes corresponding respectively to the plurality of point cloud grids based on each reference plane to obtain target planes corresponding respectively to the plurality of point cloud grids; and
performing denoise processing on the plurality of sampling points in each point cloud grid based on the target plane corresponding to the point cloud grid.

14. The storage medium of claim 13, wherein, correcting the initial planes corresponding respectively to the plurality of point cloud grids based on each reference plane to obtain the target planes corresponding respectively to the plurality of point cloud grids, comprises:
adding each reference plane to a plane set as a target plane corresponding to a point cloud grid;
performing a correction process based on any target plane in the plane set, wherein, the correction process comprises: determining a first neighbor grid of a point cloud grid corresponding to the target plane, and determining a second neighbor grid corresponding to another target plane from neighbor grids of the first neighbor grid in response to the number of sampling points matched with the initial plane corresponding to the first neighbor grid being less than the first threshold; interpolating the target plane and the another target plane corresponding to the second neighbor grid to obtain a target plane corresponding to the first neighbor grid;
updating the plane set based on the target plane corresponding to the first neighbor grid; and
repeating the correction process for any target plane in the updated plane set until each of the plurality of point cloud grids has the corresponding target plane.

15. The storage medium of claim 13, wherein, performing the denoise processing on the plurality of sampling points in each point cloud grid based on the target plane corresponding to the point cloud grid, comprises:
for each point cloud grid, inputting three-dimensional position coordinates of each sampling point in the point cloud grid into the target plane to obtain an output distance of each sampling point to the target plane; and
performing the denoise processing on the plurality of sampling points based on the output distance.

16. The storage medium of claim 15, wherein, performing the denoise processing on the plurality of sampling points based on the output distance, comprises:
determining that a normal vector of the target plane of the point cloud grid is perpendicular to the target plane and directed upwardly;
determining a first sampling point with the output distance being a negative value and less than a second threshold; and
performing the denoise processing on the plurality of sampling points by deleting the first sampling point.

17. The storage medium of claim 15, wherein, performing the denoise processing on the plurality of sampling points based on the output distance, comprises:
determining that a normal vector of the target plane of the point cloud grid is perpendicular to the target plane and directed downwardly;
determining a first sampling point with the output distance being a positive value and less than a second threshold; and
performing the denoise processing on the plurality of sampling points by deleting the first sampling point.

18. The storage medium of claim 13, wherein, the computer instructions are further configured to cause the computer to perform the followings:
determining a center point in the gridded point cloud map, wherein the center point is located at a mapping position of a laser sensor acquiring the gridded point cloud map in the gridded point cloud map; and
determining the plurality of point cloud grids each with a distance to the center point being less than a preset distance.
